(19) United States
(12) Patent Application Publication
(10) Pub. No.: US 2015/0136559 A1
(43) Pub. Date: May 21, 2015

(54) ELECTROMAGNETIC CLUTCH

(71) Applicant: Magna Powertrain of America, Inc., Troy, MI (US)

(72) Inventors: Jesse Brumberger, East Syracuse, NY (US); Timothy M. Burns, Elbridge, NY (US); Anupam Sharma, East Syracuse, NY (US); Hsing-Hua Fan, Baldwinsville, NY (US)

(21) Appl. No.: 14/539,030

(22) Filed: Nov. 12, 2014

Related U.S. Application Data
(60) Provisional application No. 61/906,480, filed on Nov. 20, 2013.

(51) Int. Cl. F16D 48/06; F16D 27/14

(52) U.S. Cl. CPC F16D 48/064; F16D 27/14
USPC 192/84.9

(57) ABSTRACT

A torque transfer device for a motor vehicle includes a clutch for transferring torque between first and second shafts. An electromagnetic actuator includes an axially moveable armature for applying an application force to the clutch. An actuator control system includes a force sensor positioned within a clutch actuation force load path and is operable to output a signal indicative of a force applied to the clutch. The control system includes a controller operable to control the electromagnetic actuator to vary the force applied to the clutch based on the force sensor signal. As an option, the actuator control system can include a position sensor operable to output a signal indicative of a position of the armature. The control system determines a target torque to be transferred by the clutch and a target armature position based on a previously determined clutch torque vs. armature position relationship. The control system varies an electrical input to the electromagnetic actuator to perform closed loop control of the armature position.

### CROSS REFERENCE TO RELATED APPLICATIONS

This application claims the benefit of and priority to U.S. Provisional Application No. 61/906,480, filed Nov. 20, 2013, the entire disclosure of which is incorporated herein by reference.

### FIELD

The present disclosure relates generally to power transfer systems for controlling the distribution of drive torque in motor vehicles. More particularly, the present disclosure is directed to control systems for electromagnetic clutch actuators used to control engagement of clutch units in torque transfer devices installed in motor vehicle driveline applications.

### BACKGROUND

This section provides background information related to the present disclosure which is not necessarily prior art.

In many vehicles, a power transmission device is operably installed between the primary and secondary drivelines. Such power transmission devices are typically equipped with a torque transfer mechanism which is operable for selectively and/or automatically transferring drive torque from the primary driveline to the secondary driveline to establish a four-wheel drive mode of operation.

A modern trend in four-wheel drive motor vehicles is to equip the power transmission device with a transfer clutch and an electronically-controlled traction control system. The transfer clutch is operable for automatically directing drive torque to the secondary wheels, without any input or action on the part of the vehicle operator, when traction is lost at the primary wheels for establishing an “on-demand” four-wheel drive mode. Typically, the transfer clutch includes a multi-plate clutch assembly that is installed between the primary and secondary drivelines and a clutch actuator for generating a clutch engagement force that is applied to the clutch plate assembly. The clutch actuator typically includes a power-operated device that is actuated in response to electric control signals sent from an electronic controller unit (ECU). Variable control of the electric control signal is frequently based on changes in the current operating characteristics of the vehicle (i.e., vehicle speed, interaxle speed difference, acceleration, steering angle, etc.) as detected by various sensors. Thus, such “on-demand” power transmission devices can utilize adaptive control schemes for automatically controlling torque distribution during all types of driving and road conditions.

A large number of on-demand power transmissions have been developed which utilize an electrically-controlled clutch actuator for regulating the amount of drive torque transferred through the clutch assembly to the secondary driveline as a function of the value of the electrical control signal applied thereto. In some applications, the transfer clutch employs an electromagnetic clutch as the power-operated clutch actuator. For example, U.S. Pat. No. 5,407,024 discloses an electromagnetic coil that is incrementally activated to control movement of a ball-ramp drive assembly for applying a clutch engagement force on the multi-plate clutch assembly. Likewise, Japanese Laid-open Patent Application No. 62-18117 discloses a transfer clutch equipped with an electromagnetic clutch actuator for directly controlling actuation of the multi-plate clutch pack assembly.

As an alternative, the transfer clutch may employ an electric motor and a drive assembly as the power-operated clutch actuator. For example, U.S. Pat. No. 5,323,871 discloses an on-demand transfer case having a transfer clutch equipped with an electric motor that controls rotation of a sector plate which, in turn, controls pivotal movement of a lever arm for applying the clutch engagement force to the multi-plate clutch assembly. Moreover, Japanese Laid-open Patent Application No. 63-66927 discloses a transfer clutch which uses an electric motor to rotate one cam plate of a ball-ramp operator for engaging the multi-plate clutch assembly. Finally, U.S. Pat. Nos. 4,895,236 and 5,423,235 respectively disclose a transfer case equipped with a transfer clutch having an electric motor driving a reduction gearset for controlling movement of a ball screw operator and a ball-ramp operator which, in turn, apply the clutch engagement force to the clutch pack.

While many on-demand clutch control systems similar to those described above are currently used in four-wheel drive vehicles, the cost and complexity of such systems may become excessive. In addition, control of the clutch actuation components may be challenging based on size, cost and power limitations imposed by the vehicle manufacturer. In an effort to address these concerns, simplified torque couplings are being considered for use in these applications.

### SUMMARY

This section provides a general summary of the disclosure, and is not a comprehensive disclosure of its full scope or all of its features.

In accordance with the aspects, objectives, features and characteristics detailed in the present disclosure, a torque transfer device is provided having a clutch, an electromagnetic clutch actuator, and an actuator control system configured to accurately control the drive torque transferred from a first rotary member to a second rotary member. The torque transfer device is well-suited for use in power transfer assemblies of the type used in motor vehicle applications.

A torque transfer device for a motor vehicle includes a clutch for transferring torque between first and second shafts. An electromagnetic actuator includes an axially moveable armature for applying an application force to the clutch. An actuator control system includes a position sensor operable to output a signal indicative of a position of the armature. The control system determines a target torque to be transferred by the clutch and a target armature position based on a previously determined clutch torque vs. armature position relationship. The control system varies an electrical input to the electromagnetic actuator to perform closed loop control of the armature position.

In addition, a torque transfer device for a motor vehicle includes a clutch for transferring torque between first and second shafts. An electromagnetic actuator includes a main coil and an axially moveable armature for applying an application force to the clutch. An actuator control system includes a position sensor providing a signal indicative of a position of the armature. The control system is operable to vary an electrical input to the electromagnetic actuator to perform closed loop control of the armature position. An armature position verification system includes a search coil providing a signal indicative of a magnetic flux generated by the main coil. The verification system compares the magnetic flux and the corresponding armature position signal to a predetermined flux and armature position relationship to verify the armature position.

A method for controlling a magnetic actuator for a clutch transferring torque between first and second shafts of a power transmission device in a vehicle is also discussed. The method includes determining vehicle operating characteristics and determining a target clutch torque based on the operating characteristics. A target position of an armature within the actuator is determined based on the target torque. An actual armature position is determined based on a signal provided by a position sensor. The method includes determining whether the actual armature position is within a predetermined tolerance of the target armature position. Closed loop position feedback control is performed by varying an electrical input to the electromagnetic actuator to control the position of the armature based on a position sensor signal.

A torque transfer device for a motor vehicle includes a clutch for transferring torque between first and second shafts. An electromagnetic actuator includes an axially moveable armature for applying an application force to the clutch. An actuator control system includes a force sensor positioned within a clutch actuation force load path and is operable to output a signal indicative of a force applied to the clutch. The control system includes a controller operable to control the electromagnetic actuator to vary the force applied to the clutch based on the force sensor signal.

Furthermore, a torque transfer device for a motor vehicle includes a clutch for transferring torque between first and second shafts. An electromagnetic actuator includes an axially moveable armature for applying an application force to the clutch. An actuator control system includes a force sensor operable to output a signal indicative of a force applied to the clutch. The control system determines a target torque to be transferred by the clutch and a target application force based on the target torque. The control system is operable to vary an electrical input to the electromagnetic actuator to perform closed loop control of the force applied to the clutch.

A method of controlling an electromagnetic actuator for a clutch transferring torque between first and second shafts of a power transmission device in a vehicle includes determining vehicle operating characteristics. A target clutch torque is determined based on the vehicle operating characteristics. A target clutch actuation force is determined based on the target torque. An actual clutch actuation force is determined based on a signal provided by a force sensor positioned within a clutch actuation force load path. The method determines whether the actual clutch actuation force is within a predetermined tolerance of the target clutch actuation force. Closed loop force feedback control is performed by varying an electrical input to the electromagnetic actuator to control the clutch activation force based on the force sensor signal.

It is a further aspect of the present disclosure to utilize the force derived from the secondary coil signal as part of a clutch wear compensation, detection and safety control scheme based on the flux change detected by the secondary coil.

It is a still further aspect of the present disclosure to employ a discrete voltage control method for non-PWM electromagnetic clutch actuators in combination with the secondary coils in torque transfer devices.

It is another aspect of the present disclosure to employ a bi-mode control strategy for electromagnetic clutch actuators in torque transfer devices.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary motor vehicle equipped with a torque coupling constructed and controlled in accordance with the teachings of the present disclosure;

FIG. 2 is a schematic illustration of the torque coupling shown in FIG. 1 associated with a drive axle assembly;

FIG. 3 is a sectional view of an exemplary torque coupling adapted for use with the motor vehicle applications shown in FIGS. 1 and 2;

FIG. 4 is a flow diagram depicting torque coupling control;

FIG. 5 is a graph depicting coupling torque vs. armature position;

FIG. 6 is a sectional view of an alternative construction for the torque coupling of the present disclosure;

FIG. 7 is a schematic depicting magnetic flux calculation;

FIG. 8 is a flow diagram depicting position control of the torque coupling;

FIG. 9 is a graph correlating armature position and magnetic flux at discrete currents;

FIG. 10 is an electrical schematic relating to applying discrete voltages to an electromagnetic actuator associated with the torque couplings of the present disclosure;

FIG. 11 is a graph depicting magnetic flux vs. armature position; and

FIG. 12 is a graph depicting force as a function of flux linkage.

FIG. 13 is a sectional view of another embodiment of a torque coupling constructed and controlled in accordance with the present disclosure;

FIG. 14 is a flow diagram for an actuator control strategy operable for controlling the electromagnetic clutch actuator associated with the torque coupling of FIG. 13;

FIG. 15 is a sectional view of yet another embodiment of a torque coupling constructed and controlled in accordance with the present disclosure;

FIG. 16 graphically depicts the engagement phase relationships for an electromagnetic clutch actuator using the flux sensed from a search coil to provide a feedback mechanism for calculating the target torque value using a bi-mode electromagnetic clutch control strategy;

FIG. 17 graphically depicts the disengagement phase relationship for an electromagnetic clutch actuator to provide a feedback mechanism for current control using the bi-mode electromagnetic clutch control strategy;

FIG. 18 is a flow chart for the bi-mode electromagnetic clutch control strategy;

FIG. 19 is a schematic of an electromagnetic solenoid assembly associated with the torque couplings of the present for use with a protection clutch wear detection, compensation and protection control system;

FIG. 20 is a sectional view of two different torque transfer devices associated with the control system of FIG. 19;

FIG. 21 is a flow chart associated with the clutch wear detection, compensation and protection control system of the present disclosure; and

FIG. 22 is a schematic of an air gap estimation logic associated with the clutch wear detection, compensation and protection control system of the present disclosure.

Corresponding reference numerals indicate corresponding parts throughout the several views of the drawings.

### DETAILED DESCRIPTION

The present disclosure is directed to a torque transfer mechanism that can be adaptively controlled to transfer torque between a first rotary member and a second rotary member. The torque transfer mechanism finds particular application in power transmission devices for use in motor vehicle drivelines such as, for example, a clutch in a transfer case or an in-line torque coupling or a disconnect associated with a differential unit in a transfer case or a drive axle assembly. Thus, while the present disclosure is hereinafter described in association with particular arrangements for use in specific driveline applications, it will be understood that the arrangements shown and described are merely intended to illustrate embodiments of the present disclosure.

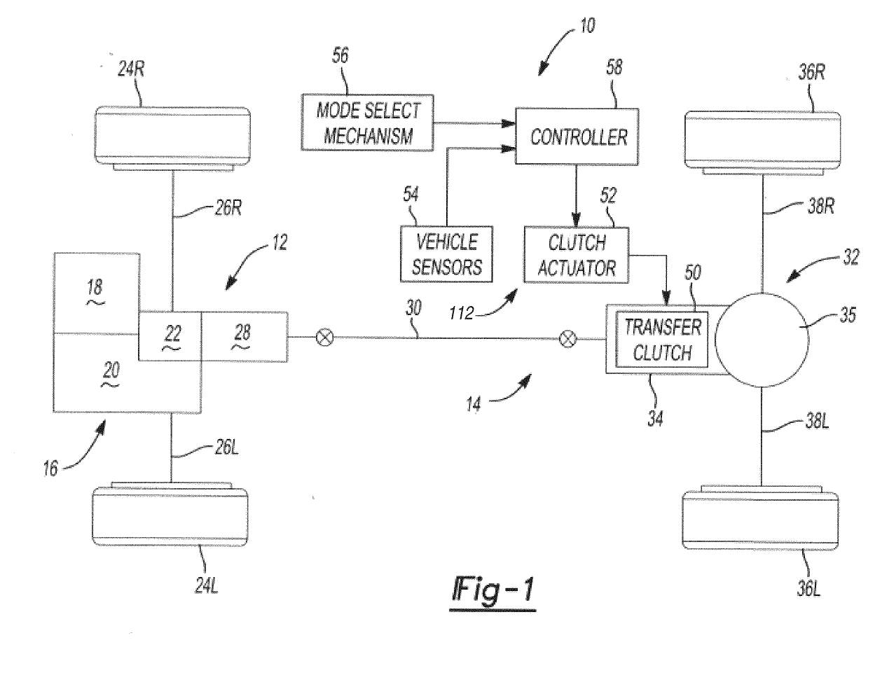

With particular reference to FIG. 1 of the drawings, a drivetrain 10 for an all-wheel drive vehicle is shown. Drivetrain 10 includes a primary driveline 12, a secondary driveline 14, and a powertrain 16 for delivering rotary tractive power (i.e., drive torque) to the drivelines 12 and 14. In the particular arrangement shown, primary driveline 12 is the front driveline while secondary driveline 14 is the rear driveline. Powertrain 16 is shown to include an engine 18 and a multi-speed transmission 20. Front driveline 12 includes a front differential 22 driven by powertrain 16 for transmitting drive torque to a pair of front wheels 24L and 24R through a pair of front axleshafts 26L and 26R, respectively. Rear driveline 14 includes a power transfer unit 28 driven by powertrain 16 or differential 22, a propshaft 30 driven by power transfer unit 28, a rear axle assembly 32 and a power transmission device 34 for selectively transferring drive torque from propshaft 30 to rear axle assembly 32. Rear axle assembly 32 is shown to include a rear differential 35, a pair of rear wheels 36L and 36R and a pair of rear axleshafts 38L and 38R that interconnect rear differential 35 to corresponding rear wheels 36L and 36R.

With continued reference to the drawings, drivetrain 10 is shown to further include an electronically-controlled power transfer system for permitting a vehicle operator to select a two-wheel drive mode, a locked (“part-time”) four-wheel drive mode or an “on-demand” mode. In this regard, power transmission device 34 is equipped with a transfer clutch 50 that can be selectively actuated for transferring drive torque from propshaft 30 to rear axle assembly 32 for establishing the part-time and on-demand four-wheel drive modes. The power transfer system further includes a power-operated clutch actuator 52 for actuating transfer clutch 50, vehicle sensors 54 for detecting certain dynamic and operational characteristics of the motor vehicle, a mode select mechanism 56 for permitting the vehicle operator to select one of the available drive modes, and a controller 58 for controlling actuation of clutch actuator 52 in response to input signals from vehicle sensors 54 and mode select mechanism 56.

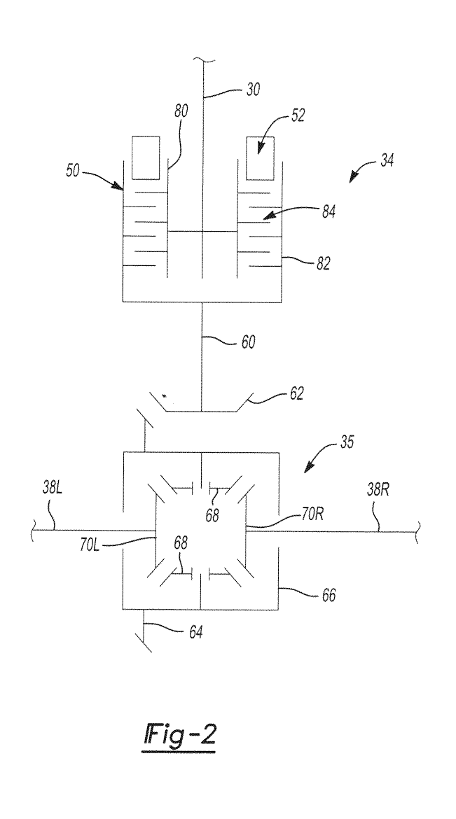

Power transmission device 34, hereinafter referred to as torque coupling 34, is shown schematically in FIG. 2 to be operably disposed between propshaft 30 and a pinion shaft 60. As seen, pinion shaft 60 includes a pinion gear 62 that is meshed with a hypoid ring gear 64 that is fixed to a differential case 66 of rear differential 35. Differential 35 is conventional in that pinions 68 driven by case 66 are arranged to drive side gears 70L and 70R which are fixed for rotation with corresponding axleshafts 38L and 38R. Torque coupling 34 is shown to include transfer clutch 50 and clutch actuator 52 arranged to control the transfer of drive torque from propshaft 30 to pinion shaft 60 and which together define the torque transfer mechanism of the present disclosure.

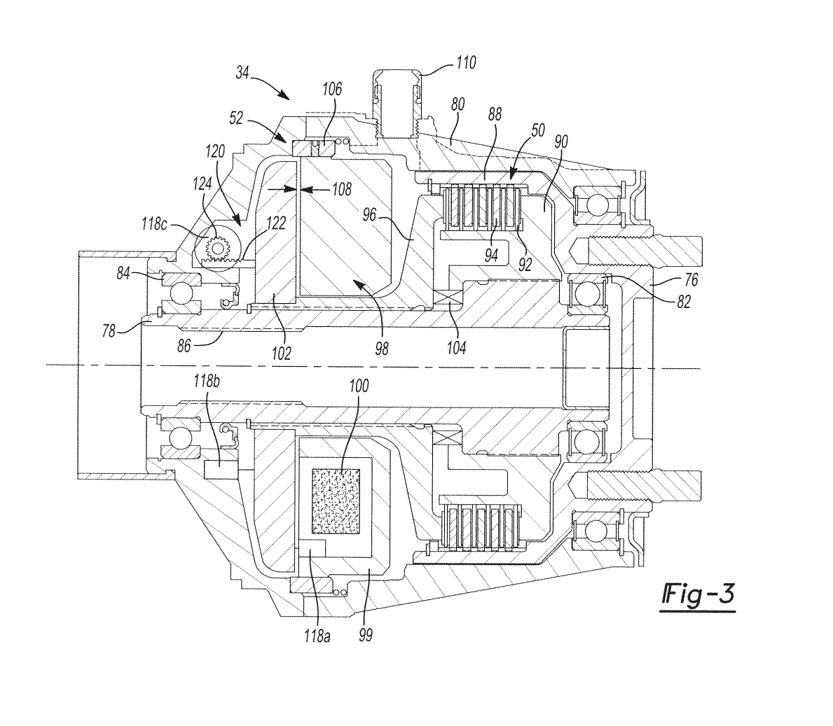

Referring primarily to FIG. 3, the components and function of torque coupling 34 will be disclosed in detail. As seen, torque coupling 34 generally includes a rotary input member 76 and a rotary output member 78 supported for rotation relative to one another within a housing 80 by a bearing 82. Another bearing 84 supports rotary output member 78 within housing 80. Rotary input member 76 is fixed for rotation with propshaft 30. Rotary output member 78 is fixed for rotation with pinion shaft 60 via a spline connection 86.

Transfer clutch 50 includes a drum 88 integrally formed with rotary input member 76. A hub 90 is fixed for rotation with rotary output member 78. A plurality of inner clutch plates 92 are fixed for rotation with hub 90. A plurality of outer clutch plates 94 are fixed for rotation with drum 88. Inner and outer clutch plates 92, 94 are interleaved with one another. An apply plate 96 is fixed for rotation with and axially moveable relative to rotary output member 78.

Clutch actuator 52 includes a coil assembly 98 including a housing or core 99 fixedly mounted within housing 80. A main coil 100 is positioned with cup-shaped core 99. An axially moveable armature 102 is fixed to apply plate 96 and positioned in close proximity to coil assembly 98. A return spring 104 biases apply plate 96 away from inner and outer clutch plates 92, 94. In similar fashion, spring 104 biases armature 102 away from coil assembly 98.

Apply plate 96 and armature 102 are moveable from a retracted position shown in FIG. 3 to an advanced position where apply plate 96 compresses inner clutch plates 92 and outer clutch plates 94 together to transfer torque across transfer clutch 50. The position of coil assembly 98 may be varied through the use of an adjustment mechanism 106 interconnecting core 99 and housing 80. As such, a gap 108 between armature 102 and coil assembly 98 may be adjusted prior to the completion of assembly of torque coupling 34 to account for various dimensional tolerances of the torque coupling components. A wire terminal 110 is fixed to housing 80 and contains wires for the supply of current to main coil 100.

Controller 58 is in electrical communication with coil assembly 98. Torque coupling 34 may be operated in a torque transferring mode by passing current through coil assembly 98 in response to a command from controller 58. A magnetic flux is formed along a closed magnetic circuit including core 99 and armature 102, that are made from magnetic materials. Armature 102 is attracted toward coil assembly 98. As a result, apply plate 96 compresses inner clutch plates 92 with outer clutch plates 94 to transfer torque between rotary input member 76 and rotary output member 78.

An actuator control system 112 includes controller 58, vehicle sensors 54 and a position sensor 118. FIG. 3 depicts three different arrangements of sensor 118 identified at reference numerals 118a, 118b and 118c. It is contemplated that sensor 118 may be a linear variable displacement transducer, a linear potentiometer, a hall effect sensor, an optical sensor using laser or infrared emissions, an ultrasound sensor or the like.

Sensor 118a is embedded within coil assembly 98 and fixed to core 99. Sensor 118a is operable to measure a position of armature 102 relative to coil assembly 98 or an absolute measurement of gap 108. Sensor 118 may be alternatively located at the location depicted as 118b.

Sensor 118b is fixed to housing 80 and is operable to directly measure movement of armature 102 relative to housing 80. Because coil assembly 98 is also fixed to housing 80, a relative measurement of gap 108 may be obtained through the use of sensor 118b.

Sensor 118c may be fixed to housing 80 and cooperate with a multiplier 120 useful for amplifying the travel in armature 102 to provide greater resolution for the control of position. More particularly, multiplier 120 is depicted as a rack 122 fixed to armature 102. A pinion gear 124 is meshingly engaged with rack 122 such that axial translation of rack 122 causes rotation of pinion gear 124. Sensor 118c detects changes in the rotary position of pinion gear 124. It is contemplated that other multipliers such as a lever system may be used in lieu of the rack and pinion arrangement depicted in FIG. 3.

FIG. 4 provides a logic flow diagram relating to the control of torque coupling 34. At block 200, vehicle sensors 54 provide signals indicative of driver inputs and various vehicle operating characteristics to controller 58. The signals may indicate vehicle speed, individual wheel speeds, transmission gear ratio, steering angle, engine speed, throttle position, ambient temperature, and slip speed between input member 76 and output member 78 among other vehicle characteristics. At block 202, a target torque to be transferred across torque coupling 34 is determined based upon the vehicle operating characteristics and driver inputs. The target torque may include a magnitude of zero torque where torque transfer across torque coupling 34 is not desired.

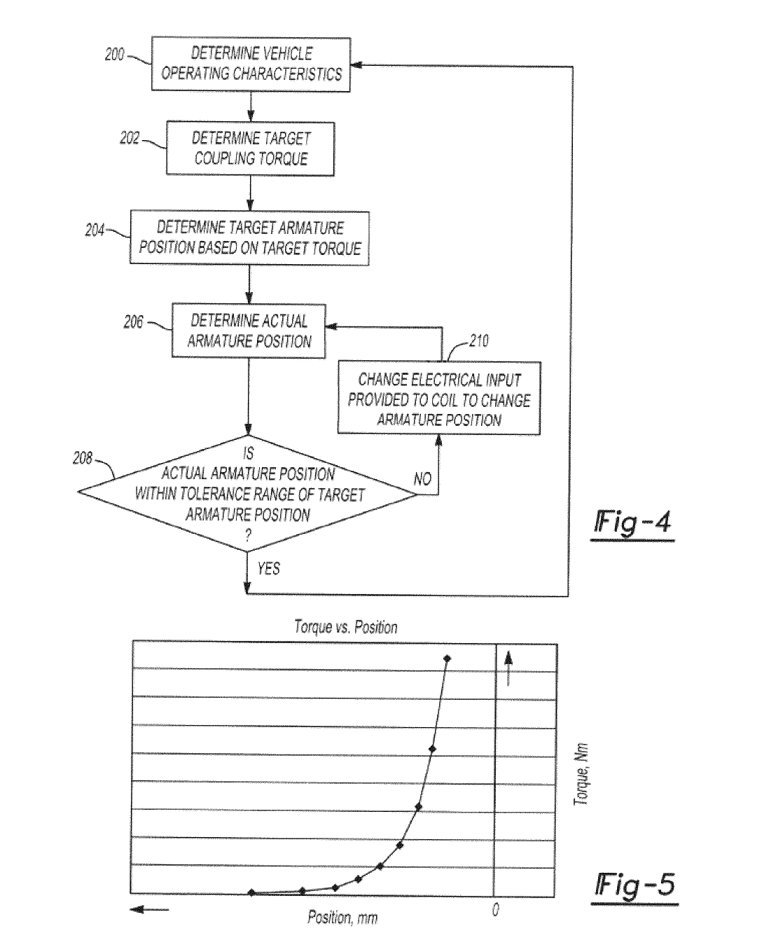

At block 204, a target position of armature 102 is determined based on the target torque determined at block 202. Controller 58 may be programmed with or have access to a look-up table or may execute an algorithm of a previously determined relationship between armature position and coupling torque as illustrated at FIG. 5. It is contemplated that the armature position vs. torque relationship may be empirically generated by applying a number of different electrical inputs having various magnitudes to main coil 100. The resulting position and torque relationship is saved in the look-up table. In one arrangement, application of current to main coil 100 may be set at a 100% PWM duty cycle and a number of different resistors may be added to the circuit to provide discrete electrical input magnitudes to main coil 100. The position of armature 102 and the coupling torque associated with each different magnitude of input are stored.

At block 206, an actual armature position is determined based on the output of one of position sensors 118a, 118b or 118c.

At block 208, the actual armature position is compared to the target armature position. If the actual armature position is within a predetermined tolerance range of the target armature position, control returns to block 200. If the actual armature position is outside of the tolerance range of the target armature position, controller 58 varies an electrical input to coil assembly 98 to change the armature position in an attempt to meet the target armature position at block 210. Control returns to block 206 where the new actual position is compared to the target armature position. Closed loop position control continues until the conditions of block 208 have been met.

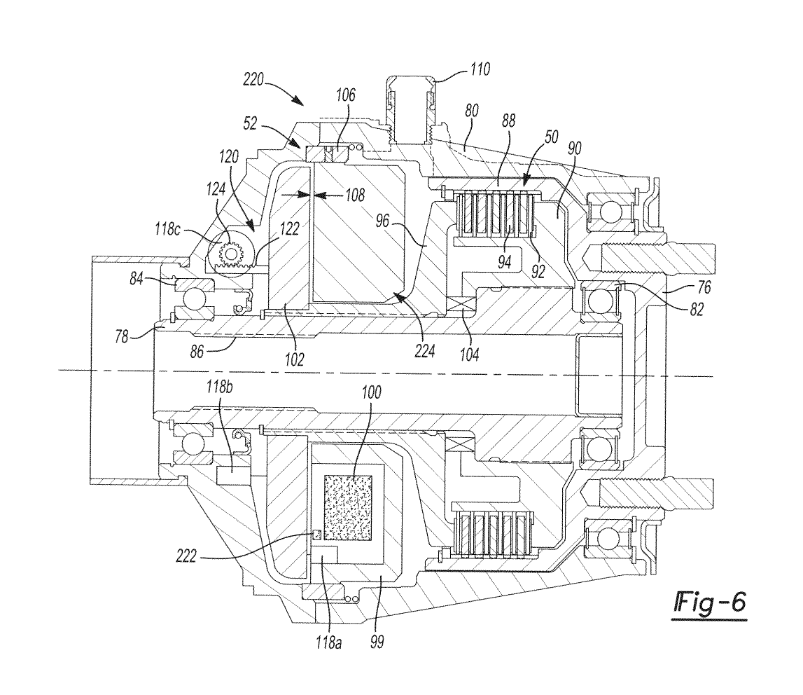

FIG. 6 illustrates an alternate torque coupling 220 including a search coil 222 embedded within a coil assembly 224. Coil assembly 224 is substantially similar to coil assembly 98 with the addition of search coil 222. The remaining components of torque coupling 220 are substantially similar to torque coupling 34. Accordingly, similar elements will retain the earlier introduced reference numerals. Search coil 222 is positioned proximate main coil 100 such that a magnetic flux density φ is generated along the magnetic circuit when current is supplied to main coil 100. An induced electromotive force, V, is generated in search coil 222 in response to the change in magnetic flux density. The induced electromotive force generated in search coil 222 is input to controller 58.

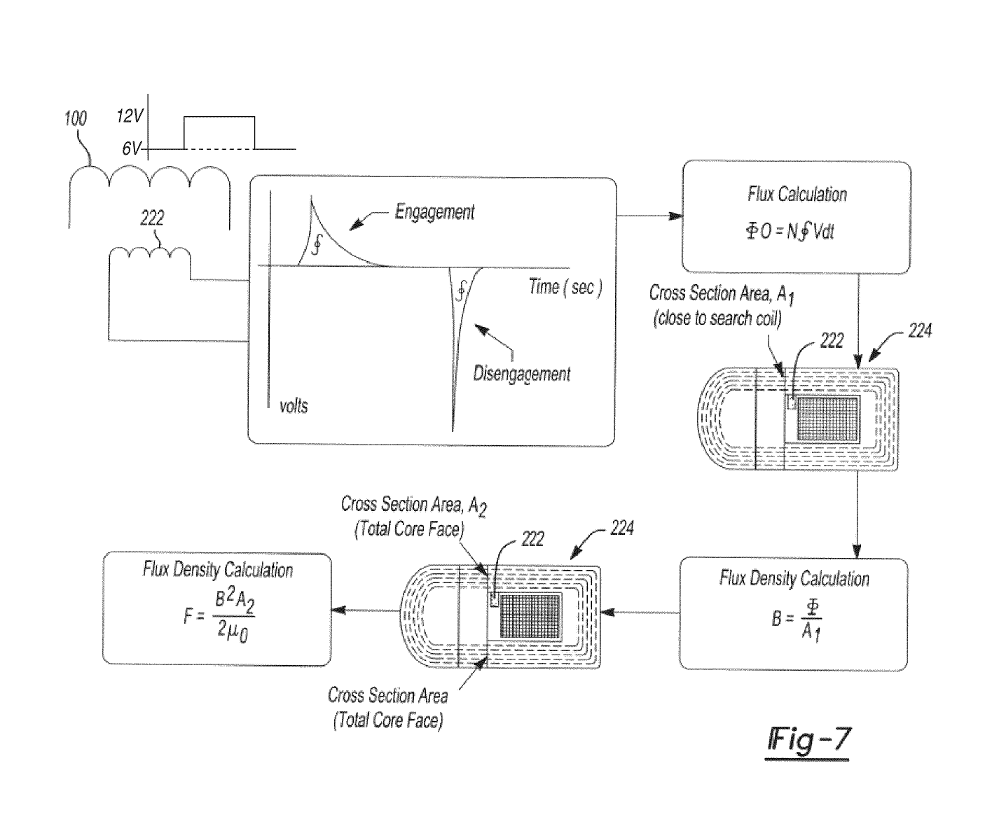

FIG. 7 depicts the induced electromotive force that occurs during initial current supply to main coil 100 and engagement of apply plate 96 with inner and outer clutch plates 92, 94. Another induced electromotive force occurs when power supply is discontinued to main coil 100. When the supply of power to main coil 100 is ceased, spring 104 causes apply plate 96 to disengage inner and outer clutch plates 92, 94.

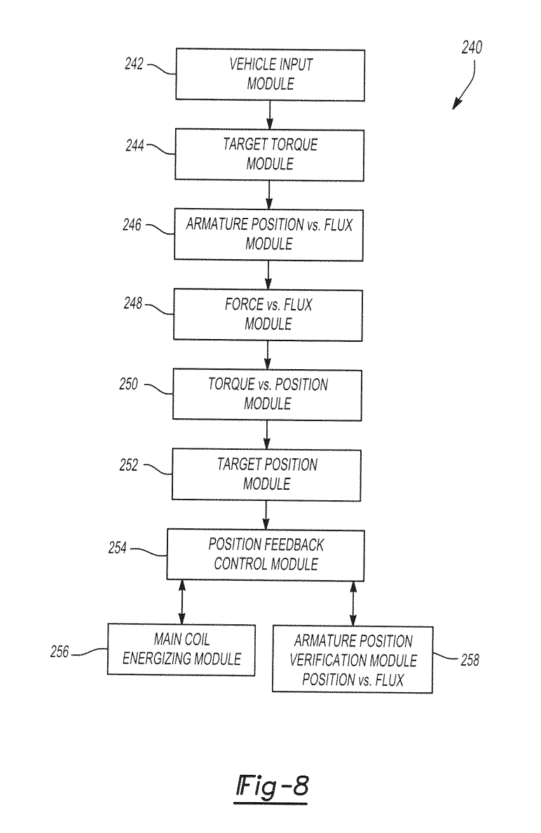

FIG. 8 provides a logic diagram relating to an actuator control system 240 for the control of torque coupling 220. Control system 240 includes a vehicle input module 242 for collecting the data provided by vehicle sensors 54. A target torque module 244 is in receipt of the data from vehicle input module 242 and determines a target torque to be generated by transfer clutch 50.

Control system 240 also includes a series of control modules associated with the individual torque characteristics of each torque coupling 220 manufactured. It is contemplated that modules 246, 248 and 250 are envoked at the manufacturing facility during a final torque coupling test prior to installation on a vehicle. By testing and collecting various data for each torque coupling in this manner, a number of manufacturing variables including dimensional stack-ups, friction coefficients, component compliance and assembly variations may be taken into account.

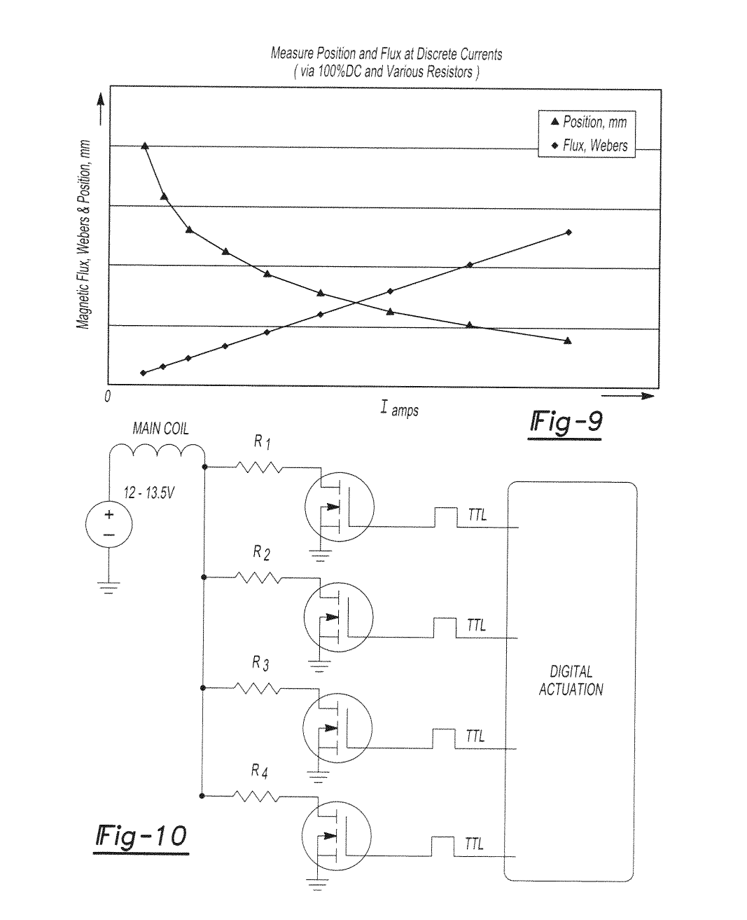

An armature position vs. flux module 246 generates a magnetic flux vs. current data set and an armature position vs. current data set as represented by the curves shown at FIG. 9. It should be noted that when armature 102 is furthest from coil assembly 98, the magnetic flux acting on armature 102 is at a minimum. As armature 102 moves toward coil assembly 98, magnetic flux increases. It should be appreciated that module 246 not only incorporates the change in gap 108 as armature 102 moves toward coil assembly 98, but also accounts for component compliance after apply plate 96 has caused each of inner clutch plates 92 to engage outer clutch plates 94.

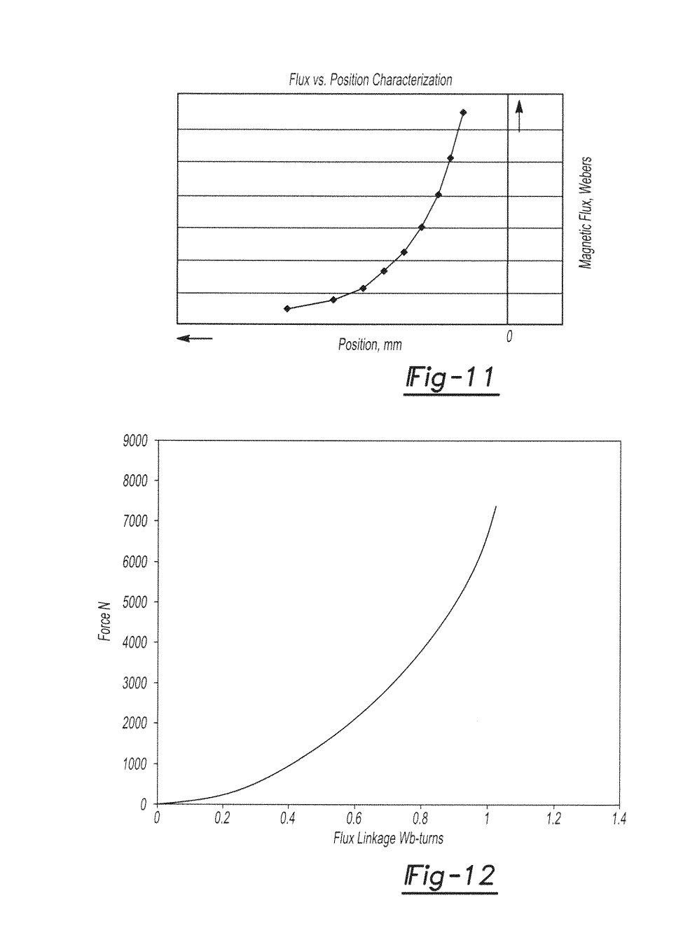

It is contemplated that the magnetic flux vs. current and armature position vs. current curves may be generated by applying a 100% pulse width modulation duty cycle to main coil 100. Discrete voltages of different magnitude may be provided to main coil 100 through the use of a number of resistors R1, R2, R3 and R4 arranged in parallel as shown in FIG. 10. Using the information from FIG. 9, module 246 defines the relationship between magnetic flux and armature position as shown in FIG. 11.

During laboratory testing of torque coupling 220, it was determined that controlling the torque output of transfer clutch 50 via current control included several challenges such as accounting for a relatively large inrush of current when power was initially provided to main coil 100. A relatively large hysteresis exists in the current vs. torque curve during switching on and off of the current to coil assembly 98. The present control scheme of applying a 100% duty cycle in combination with various resistors minimizes the hysteresis associated with the application of current to main coil 100 and allows computation of an accurate armature position vs. magnetic flux trace as determined by module 246 and depicted at FIG. 11.

Thus, the present disclosure provides for a discrete voltage control method for non-PWM electromagnetic actuation of coil assemblies equipped with a secondary coil, commonly referred to as a search coil 222. The usage of a single (or multiple) search coils 222 can provide the necessary feedback mechanism for the apply force generated by main coil 100 of coil assembly 98. One popular solenoid actuation method is PWM current control since it provides a cost effective and packaging space advantage. However, the frequency threshold of the PWM driver may be limited and could create issues for the monitor signal using search coil 222 due to the mutual induction effect of main coil 100. As noted, the flux of the main coil 100 is obtained through integration of the electromotive force and voltage from search coil 222. If the energizing voltage is a pulse (see FIG. 7), the measured voltage from the secondary coil 222 will have two clean peaks, one peak for energizing and another peak for de-energizing. However, with conventional PWM control, the current passing through the main coil 100 can be somewhat rippled which can result in significant variations in flux detection by the search coil 222.

Accordingly, the present disclosure is directed to employing a simple discrete voltage control strategy and mechanism configured to supply “cleaner” current across the main coil 100 when energizing. FIG. 10 illustrates a plurality of parallel power resistors (R1-R4) in series with main coil 100. Each coil+resister combination is controlled by a regular TTL with a MOSFET. By turning on and off the MOSFET in different combinations, a discrete supply voltage to the main coil 100 can be obtained. As such, more accurate flux information can be provided from the search coil 222.

Referring back to FIG. 8, module 248 determines the force acting on armature 102 as a function of magnetic flux. As shown in FIG. 12, the force applied to armature 102 varies as a function of magnetic flux density. More particularly, the force F acting on armature 102 given by the following equation:

$$F = \frac{{B}^{2} {A}_{2}}{2 {μ}_{0}}$$

$$where$$

$$B = \frac{Φ}{{A}_{1}}$$

$${A}_{2} = Area 2$$

$${μ}_{0} = 4 \times π \times {10}^{- 7}$$

$$Φ = N ∮ V d t$$

$${A}_{1} = Area 1$$

Once the apply force to transfer clutch 50 is known, a torque vs. position module 250 estimates the torque transferred between input member 76 and output member 78 based on the friction coefficients between the surfaces of inner clutch plates 92 and outer clutch plates 94, the radii at which they contact, and a number of other factors such as operating temperature, relative speed between input member 76 and output member 78 and others. As previously described, the torque generated by torque coupling 220 may be directly measured at the manufacturing facility prior to installation within vehicle 10.

The relationship of torque vs. position is stored within or is accessible to controller 58 such that position data provided by sensors 118a, 118b or 118c may be taken into account when attempting to provide the target coupling torque determined by module 244. Once modules 246, 248 and 250 have generated a torque vs. position trace, coupling 220 may be installed within a vehicle.

Target position module 252 determines a target armature position based on the target torque determined by module 244 and the information stored within torque vs. position module 250. A position feedback control module 254 is in communication with position sensors 118 and compares the actual position of armature 102 to the target position defined by module 252. If the actual armature position is not within a predetermined tolerance of the target armature position, main coil energizing module 256 varies a magnitude of an electrical input to main coil 100 to provide closed loop position control of armature 102.

From time to time, it may be desirable to verify the position of armature 102 with another method other than the use of position sensors 118. An armature position verification module 258 performs an armature position vs. magnetic flux data collection sequence using resistors R1, R2, R3 and R4 at a 100% duty cycle as previously described. The armature position vs. flux curve previously defined by module 246 at the manufacturing facility is compared with the verification trace generated by module 258. If the variance between the two curves exceeds a predetermined quantity, an error signal may be provided. It is contemplated that armature position verification module 258 may function during a torque request while the motor vehicle is moving or at a time when the vehicle is not moving and a target torque request is zero.

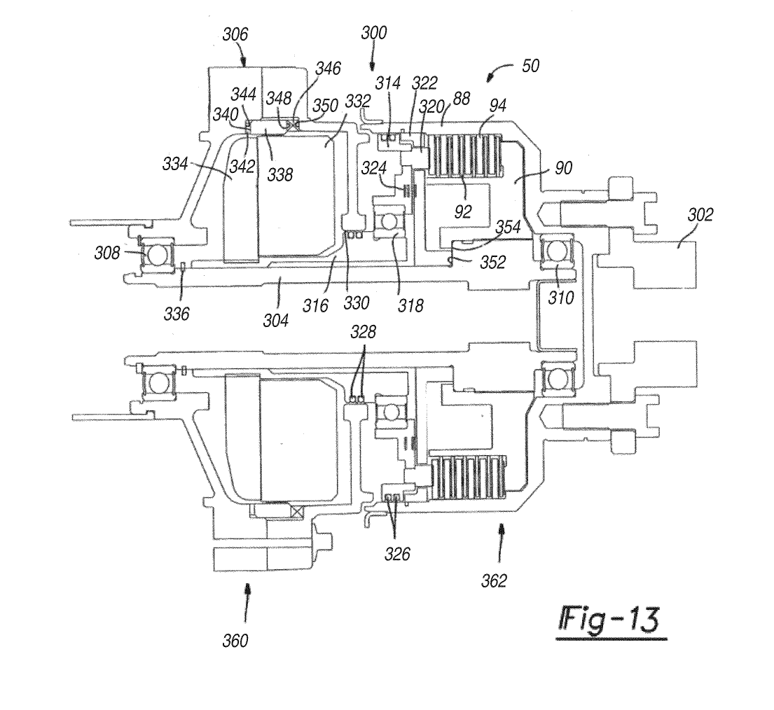

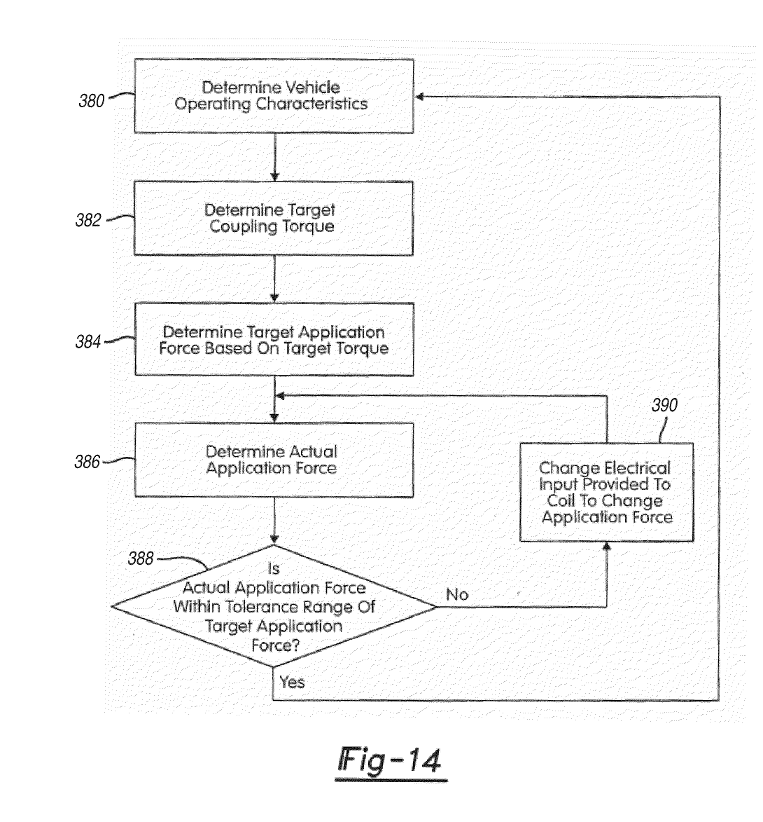

Referring primarily to FIG. 13, the components and function of another embodiment of torque coupling 300 will be disclosed in detail. As seen, torque coupling 300 generally includes a rotary input shaft 302 and a rotary output shaft 304 supported for rotation relative to one another within a housing 306 by a bearing 308. Another bearing 310 supports rotary output shaft 304. Rotary input shaft 302 is fixed for rotation with propshaft 30. Rotary output shaft 304 is fixed for rotation with pinion shaft 60 via a spline connection 312.

Transfer clutch 50 includes a drum 88 fixed for rotation with rotary input shaft 302. A hub 90 is fixed for rotation with rotary output shaft 304. A plurality of inner clutch plates 92 are fixed for rotation with hub 90. A plurality of outer clutch plates 94 are fixed for rotation with drum 88. Inner and outer clutch plates 92, 94 are interleaved with one another. An apply plate 314 is rotatably supported on an apply tube 316 by a bearing 318. Bearing 318 is captured such that apply plate 314, bearing 310 and apply tube 316 translate as a unit. A plurality of circumferentially spaced apart pins 320 extend through a support plate 322 that is fixed to drum 88. A return spring 324 is positioned between support plate 322 and apply plate 314 to bias apply plate 314 toward a first or returned positioned. It should be appreciated that pins 320 may be integrally formed with apply plate as a monolithic, one-piece component. At the returned position, pins 320 do not apply the compressive force to inner and outer clutch plates 92, 94. Seals 326 are provided between apply plate 314 and drum 88 to resist ingress of contaminants to the inner volume of drum 88 containing inner clutch plates 92 and outer clutch plates 94. Another pair of seals 328 are provided between apply tube 316 and a bore 330 extending through a first portion of housing 306.

Clutch actuator 52 includes a stator 332 positioned within housing 306. An axially moveable armature 334 is fixed to apply tube 316 and positioned in close proximity to stator 332. Return spring 324 biases apply tube 316 and armature 334 away from stator 332. Travel of apply tube 316 is limited by a retaining ring 336. It should be appreciated that apply tube 316 is axially and rotatably moveable relative to rotary output shaft 304 and that armature 334, stator 332, apply tube 316 and housing 306 do not rotate during operation of transfer clutch 50. An adjustment ring 338 is threadingly engaged with stator 332 to vary the position of an end face 340 of adjustment ring 338. A piezoelectric ring 342 is positioned between end face 340 and a land 344 of a second portion of housing 306. A biasing spring 346 acts on an end face 348 of adjustment ring 338 opposite end face 340. Spring 346 engages a seat 350 formed on housing 306. Spring 346 biases stator 332 and adjustment ring 338 toward the second housing portion. At initial assembly, adjustment ring 338 is rotated relative to stator 332 to assure that spring 346 applies a predetermined compressive load to adjustment ring 338, piezoelectric ring 342 and the second housing portion. In this manner, adjustment ring 338 is operable to account for variants in component tolerances. It should be appreciated that adjustment ring 338 may be eliminated and a shim may be added during assembly to account for dimensional variation.

The second housing portion rotatably supports rotary output shaft 304 via bearing 308. Bearing 308 is coupled in such a manner that rotary output shaft 304 is restricted from axial movement relative to the second housing portion.

Armature 334, apply tube 316, bearing 318, apply plate 314 and pins 320 are axially moveable from a retracted position to an advanced position where pins 320 compress inner clutch plates 92 and outer clutch plates 94 together to transfer torque across transfer clutch 50. Armature 334 is drawn toward stator 332 when current is passed through stator 332. Furthermore, controller 58 is an electrical communication with stator 332. Torque coupling 300 may be operated in a torque transferring mode by passing current through stator 118 in response to a command from controller 58.

An actuator control system includes controller 58, vehicle sensors 54 and piezoelectric ring 342. Piezoelectric ring 342 is placed within the load path generated during electrical excitation of stator 332. The load path created during the transfer of torque across transfer clutch 50 includes stator 332, adjustment ring 338, piezoelectric ring 342, the second housing portion, bearing 308, rotary output shaft 304, hub 90, inner and outer clutch plates 92, 94, pins 320, apply plate 314, bearing 318, apply tube 316 and armature 334. The load path between hub 90 and rotary output shaft 304 includes an enlarged stepped diameter portion 352 of rotary output shaft 304 engaging a radially inward extending flange 354 of hub 90. Piezoelectric ring 342 is operable to output a signal indicative of the compressive force between adjustment ring 338 and the second housing portion. The position of piezoelectric ring 342 is merely exemplary. For example, it is contemplated that piezoelectric ring 342 may be alternatively integrated into other components including stator 332, adjustment ring 338, the rear housing portion, or the interconnection between bearing 308 and the rear housing portion. The piezoelectric ring 342 may reside at nearly any location within the stationary portion of transfer clutch 50 as previously described. Furthermore, separate piezoelectric elements may be circumferentially spaced apart in lieu of using piezoelectric ring 342.

Based on the arrangement of components previously described, it should be appreciated that a first assembly 360 may be defined as including housing 306, apply tube 316, stator 332, armature 334, spring 324, adjustment ring 338, and piezoelectric ring 342. Subassembly 360 may be assembled at a location separate from the assembly location of the other components of transfer clutch 50. Entry of contaminants within housing 306 may be minimized during the assembly process and during functional use of transfer clutch 50. Another subassembly 362 may be defined to include drum 88, hub 90, inner and outer clutch plates 92, 94, rotary output shaft 304, bearing 310, support plate 322, pins 320 and apply plate 314. Through the use of subassemblies 360, 362, a heat generated through the frictional interconnection of inner clutch plates 92 and outer clutch plates 94 may be readily transferred to drum 88. Drum 88 is positioned in communication with the atmosphere to facilitate heat rejection from transfer clutch 50. Furthermore, subassembly 360 is separate from and spaced apart from subassembly 362 to shield electromagnetic actuator 52 from the heat generated by transfer clutch 50. It is contemplated that more accurate clutch control may be achieved by maintaining a relatively constant temperature of stator 332 throughout operation of torque coupling 300.

FIG. 14 provides a logic flow diagram relating to the control of torque coupling 300. At block 380, vehicle sensors 54 provide signals indicative of driver inputs and various vehicle operating characteristics to controller 58. The signals may indicate vehicle speed, individual wheel speeds, transmission gear ratio, steering angle, engine speed, throttle position, ambient temperature, and slip speed between input shaft 302 and output shaft 304 among other vehicle characteristics. At block 382, a target torque to be transferred across torque coupling 300 is determined based upon the vehicle operating characteristics and driver inputs. The target torque may include a magnitude of zero torque where torque transfer across torque coupling 300 is not desired.

At block 384, a target clutch application force is determined based on the target torque determined at block 382. Controller 58 may be programmed with or have access to a look-up table or may execute an algorithm of a previously determined relationship between application force and coupling torque. It is contemplated that the clutch actuation force vs. torque trace may be empirically generated by applying a number of different electrical inputs having various magnitudes to stator 332. The resulting application force and torque relationship is saved in the look-up table.

At block 386, an actual clutch application force is determined based on the output of piezoelectric ring 342. At block 388, the actual application force is compared to the target application force. If the actual application force is within a predetermined tolerance range of the target application force, control returns to block 380. If the actual application force is outside of the tolerance range of the target application force position, controller 58 varies an electrical input at block 390 to stator 332 to change the application force in an attempt to meet the target application force. Control returns to block 386 where the new application force is compared to the target application force. Closed loop position control continues until the conditions of block 388 have been met.

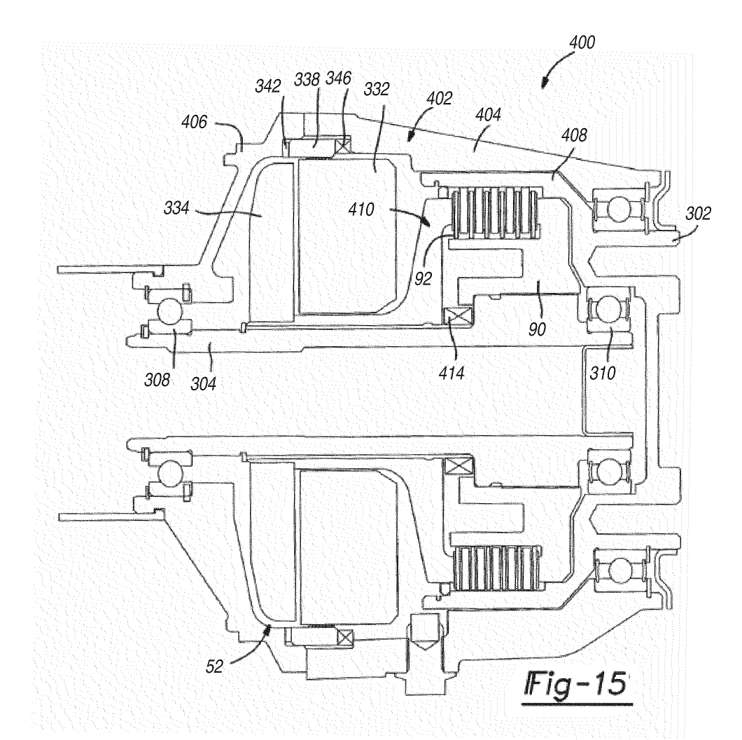

FIG. 15 depicts an alternate torque coupling 400. Torque coupling 400 is substantially similar to torque coupling 300. Accordingly, similar elements will be identified with like reference numerals. Furthermore, due to the similarities between the couplings, only the differences will be highlighted. Torque coupling 400 includes a housing 402 including a first portion 404 fixed to a second portion 406. A drum 408 is supported for rotation and positioned within housing 402. Rotary input shaft 302 is integrally formed with drum 408. An apply plate 410 is fixed for rotation with and is axially moveable relative to rotary output shaft 304. Armature 334 is fixed to apply plate 410. Accordingly, rotary output shaft 304, armature 334, apply plate 410, inner clutch plates 92 and hub 90 rotate and translate at the same speed. A return spring 414 urges apply plate 410 and armature 334 toward their retracted position. Piezoelectric ring 342 remains in the load path as previously described in relation to torque coupling 300. Closed loop feedback control may be achieved based on the force applied by electromagnetic actuator 52 and indicated by piezoelectric ring 342 as previously described in relation to torque coupling 300.

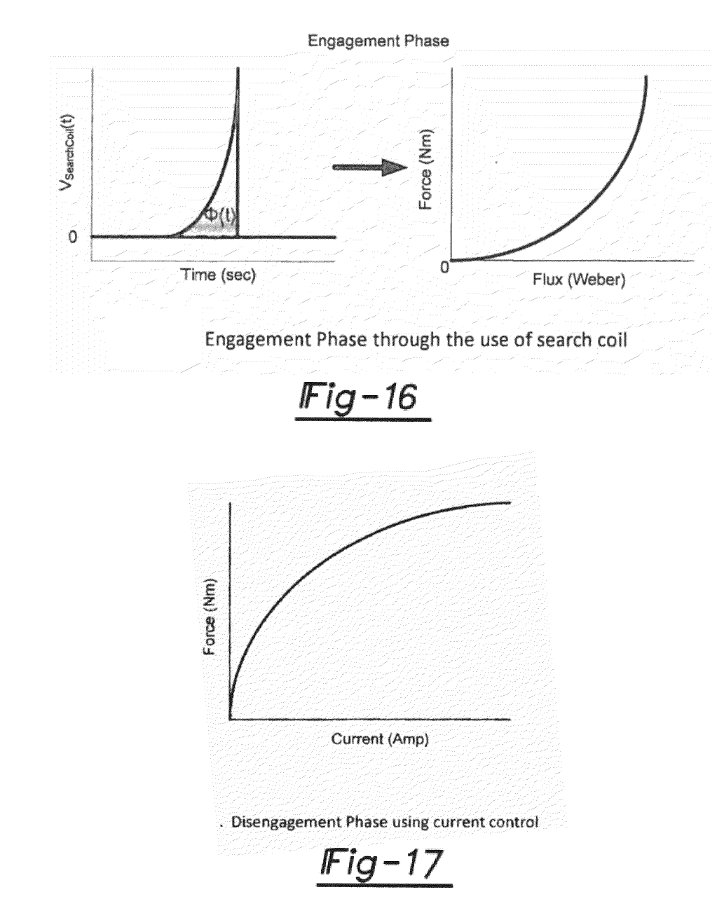

The present disclosure is further directed to a dual or bi-mode control strategy for use with the electromagnetic clutch actuation systems shown and described previously in association with any of the torque couplings 34, 220, 300 and 400. FIGS. 16-18 are directed to this enhanced control strategy, and particularly to any torque couplings equipped with a secondary or search coil. Specifically, the electromagnetic clutch actuator is controlled using a first control strategy for torque increasing requests and using a second control strategy for torque decreasing requests. When a torque increase is requested, the clutch engagement force applied to clutch 50 by clutch actuator 52 can be calculated using the search coil (coil 222 in torque coupling 220) using the equations shown in FIG. 7 and graphically illustrated in FIG. 16 such that the flux sensed by the search coil 222 provides the feedback mechanism used to accurately reach the target torque. In contrast, when a torque decrease is required, clutch 50 can be actuated by actuator 52 using a current modulation strategy based on unknown current vs. force relationships. The current sensor in the power driver of actuator 52 provides the feedback mechanism for accurate current control during such torque decrease conditions, as shown in FIG. 17.

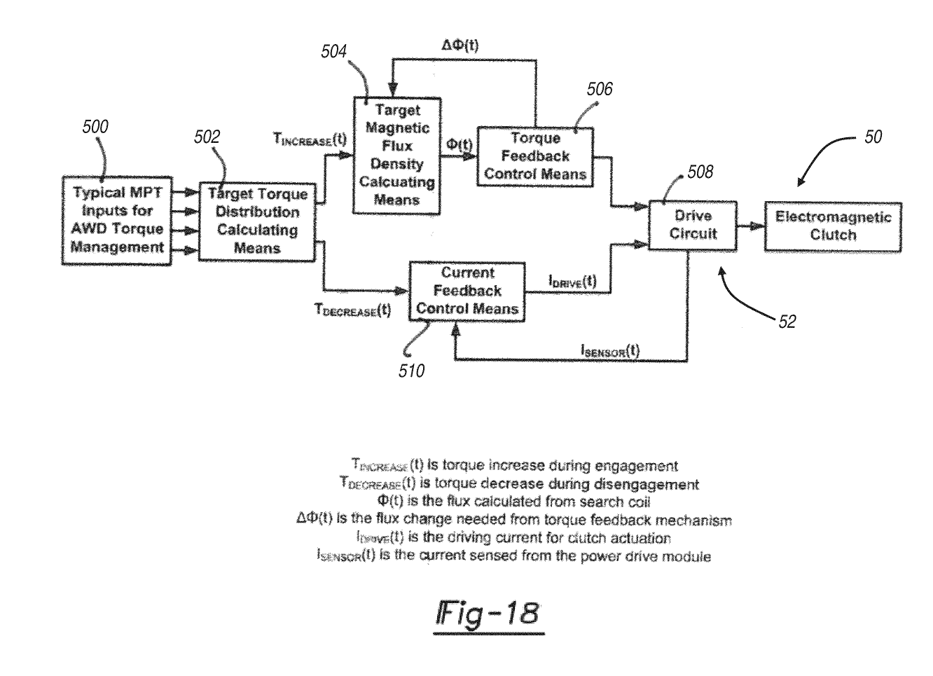

FIG. 18 illustrates a flow diagram 498 for the bi-mode clutch actuator control strategy. Specifically, at block 500, conventional inputs associated with vehicle operating characteristic and/or operator inputs are provided to a module 502 configured to calculate a target torque value. If module 502 determines that a torque increase is required during clutch engagement, then a torque increase signal (T_{INCREASE}) is provided to a module 504 configured to calculate a target magnetic flux density from the search coil. The value of the flux φ(t) calculated from the search coil is provided to a torque feedback module 502 which, in turn, calculates a change in flux AO (t) feedback to module 204 to provide a target magnetic flux value corresponding to the target torque increase (T_{INCREASE}). The corrected or adjusted target torque signal is provided to the drive circuit 508 of electromagnetic clutch actuator 52 to control actuation of clutch 50. In contrast, if module 502 determines that a torque decrease is required during clutch disengagement, then a torque decrease signal (T_{DECREASE}) is provided to a current feedback module 510 which calculates and outputs a driving current value (I_{DRIVE}) to be delivered to drive circuit 508. The current sensed by a current sensor in the power drive module (I_{SENSOR}) is fed to feedback module 510 for use in modulated current control.

The flexibility of the bi-mode control strategy provides an advantage in torque control. Engagement torque can be controlled more precisely through computation while less processing steps are needed for disengagement torque. Using force/position calculations from the search coil 222, the air gap of the electromagnetic clutch actuator 52 can be estimated. This information can be used as an indication of wear and/or damage in components of clutch 50 and prevent failure of the torque couplings.

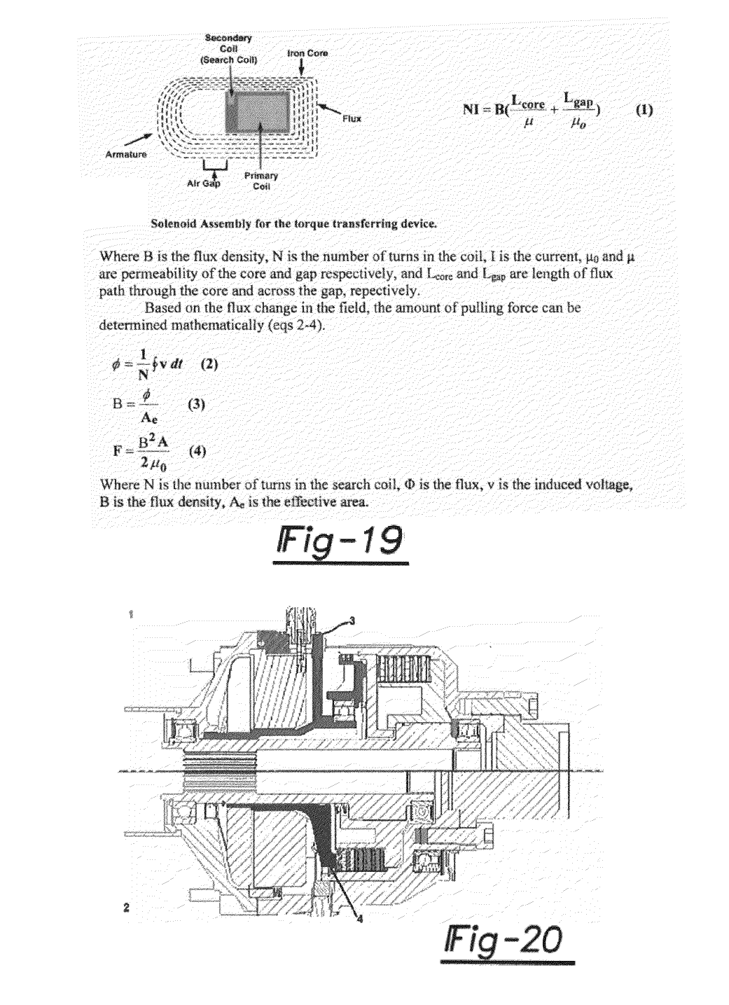

The present disclosure is further directed to a system or mechanism configured to provide a clutch wear detection feature, a compensation feature and a safety check or protection feature using the secondary coil 222 of an electromagnetic clutch actuator 52. FIGS. 19-22 are directed to this advantageous feature and should be referenced during the following detailed description. One of the crucial factors affecting the magnetic field in an electromagnetic clutch actuator 52 is the air gap between the armature and the coil housing/stator shown in FIG. 19 and equations 1 through 4. As previously discussed, use of a secondary coil 222 to monitor magnetic field strength in an electromagnetic clutch actuator 52 is known.

In accordance with this inventive concept, instead of using the electromagnetic force (F) derived from the secondary coil equations (Equations 2-4) for clutch actuation, the idea is to provide a mechanism for clutch wear detection and compensation and system protection using the flux change detected by the secondary coil. As clutch plates wear, the kiss point for engagement changes which causes the air gap to become narrower upon engagement. If the same current is applied to the coil 98 pre-wear and post-wear, the flux becomes stronger due to the reduction in the air gap. As such, the relationship between flux linkage and air gap dimension for this advanced mechanism.

As a learning mechanism, routine check-up can be performed by energizing the main coil with a suitable current at the appropriate time so there is no compromise in the vehicle dynamics. The measured flux should correlate with the default factory setting. In the situation where the air gap in the electromagnetic clutch actuator 52 starts to change, the control module can adjust the applied current to accommodate the required force needed for engagement. This provides the clutch wear compensation mechanism from the coil 98. For example: if the electromagnetic clutch actuator 52 is current controlled through PWM method, a 100% duty cycle current can be applied to the main coil at an appropriate time for learning and check-up routine. The measured flux linkage should be comparable to the predetermined factory setting. However, if significant variations occur in the comparison, then compensation should be applied. Based on the air gap and flux linkage relationship, actuation current can be adjusted to accurately produce the requested force.

As a protective mechanism for the torque transfer device, if the air gap becomes too small whether due to clutch wear or faulty actuation, the controller may set a fault code or flag which leads to release of the solenoid. A “safety check” can be performed to determine if the device needs to be repaired or can continue to function properly. Two coupling arrangements are shown in FIG. 20. For both designs, using the secondary coil as a protective mechanism can be achieved.

In the upper half (1) of FIG. 20, the clutch apply mechanism (3) consists of a tube-like section actuated by the armature of the solenoid. The tube-like section applies the load into the clutch via a bearing and an apply plate. In this configuration, the stator, armature, and apply tube are fixed preventing rotation with the clutch assembly. In the case of severe wear or damage to the clutch, it is likely that the armature and the stator will make contact. This contact should not damage the electromagnetic actuator. However, the resultant force applied to the clutch will decrease and the target torque will not be achieved. As the clutch continues to wear and/or take a compression set, more and more force will bypass the clutch until the clutch assembly will essentially spin freely. The routine check-up of the flux linkage and current relationship should indicate that the gap has been reduced below a predetermined threshold, and that there is a need to have the device repaired. Additionally, the relationship between the available engine torque, the actual slip detected across the clutch, and the expected torque capacity of the clutch based on flux linkage and current should aid in determining if the clutch mechanism has become damaged or reached its end of life.

In the lower half (2) of FIG. 20, the clutch apply mechanism (4) consists of a tube-like section actuated by the armature of the solenoid. The tube-like section applies the load into the clutch via an integrated flange section. In this configuration, there is no apply bearing or secondary apply plate. In this configuration, the stator is fixed preventing rotation, however the armature, and apply tube are fixed for rotation with the output shaft of the clutch assembly. In the case of severe wear or damage to the clutch, it is important that contact between the armature and the stator be avoided. This contact may damage the electromagnetic actuator. Not only will the resultant force applied to the clutch decrease and target torque not be achieved, but material may be transferred between the armature and stator due to contact. Additionally, the drag imposed on the armature by the grounded stator may act like a brake on the driveline. Eventually, the two components could seize resulting in a catastrophic failure. The routine check-up of the flux linkage and current relationship should indicate that the gap has been reduced below a predetermined threshold, and that there is a need to have the device repaired. It will not possible to depend on the relationship of available engine torque, detected clutch slip, and torque capacity based on flux linkage and current. Therefore, this configuration may require better sensing capabilities to ensure proper protection of the electromagnetic actuator.

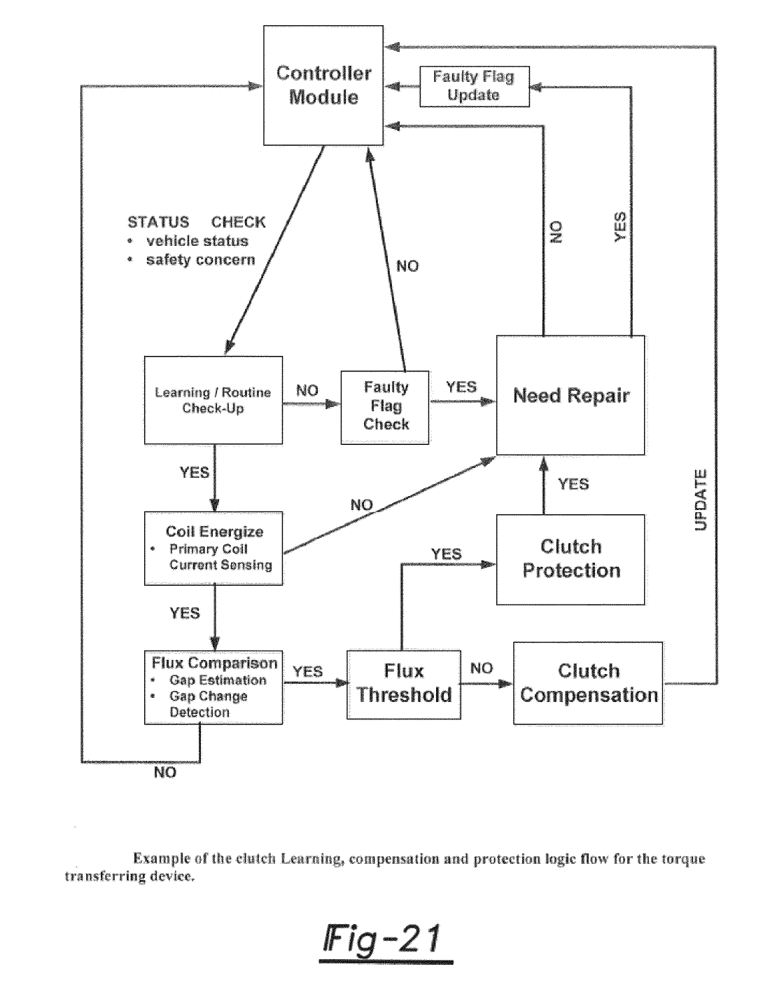

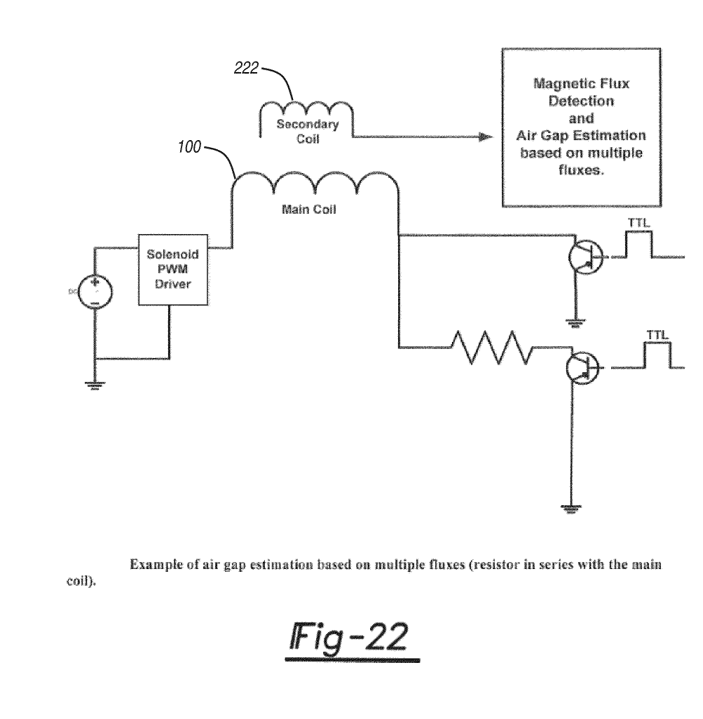

One example of the control logic flow diagram can be seen in FIG. 21, and there can be other control logics to utilize all mentioned mechanisms. In FIG. 21, “Controller Module” receives all updated status and reports back to the main powertrain controller. Once the module determines the vehicle is safe to perform the “Learning and Routine Check-up” procedure, the main coil will be energized with the full applying current. If the vehicle is not ready to perform the routine, the module will check whether there is a pre-existing faulty code in the system. If the main coil cannot be energized due to some wiring issues, faulty code will be updated. Once the main coil has been energized, the secondary coil can detect the magnetic flux and perform the estimation of the air gap. If additional resistors are used in series with the main coil, then the air gap can be estimated based on the average of different magnetic fluxes, shown in FIG. 22. Different resistors will provide different current going through the main coil and produce different magnetic flux. If the air gap has reached the safety threshold, then clutch protection will be initiated. If a change in the air gap is detected but still within the safety threshold, clutch compensation will be applied.

It is a another feature of each of the torque couplings described above that they incorporate a “dry” friction clutch in combination with direct electromagnetic clutch actuation. This arrangement permits load transfer through the hub, shaft, rear bearing and rear housing to provide improved package. The dry system also permits use of low drag seals in association with the input and output, permits use of a low current draw (i.e., 6-amps peak) and a quick pre-emptive application time (i.e. 150-200 ms).

Furthermore, the foregoing discussion discloses and describes merely exemplary embodiments of the present disclosure. One skilled in the art will readily recognize from such discussion, and from the accompanying drawings and claims, that various changes, modifications and variations may be made therein without departing from the spirit and scope of the disclosure as defined in the following claims.

What is claimed is:

1. A torque transfer device for a motor vehicle, comprising:
a first shaft;
a second shaft;
a clutch for transferring torque between the first and second shafts;
an electromagnetic actuator including an axially moveable armature for applying an application force to the clutch; and
an actuator control system including a feedback subassembly and being operable to vary an electrical input to said electromagnetic actuator to perform closed loop control of said armature.

2. The torque transfer device of claim 1 wherein said feedback subassembly includes a position sensor operable to output a signal indicative of a position of said armature and said control system determining a target torque to be transferred by said clutch and a target armature position based on a previously determined clutch torque vs. armature position relationship.

3. The torque transfer device of claim 1 wherein said electromagnetic actuator includes a main coil and wherein said feedback subassembly includes a position sensor operable to output a signal indicative of a position of said armature and an armature position verification system including a search coil providing a signal indicative of a magnetic flux generated by said main coil, said verification system comparing the magnetic flux and the corresponding armature position signal to a predetermined flux and armature position relationship to verify the position of said armature.

4. The torque transfer device of claim 3 further including a plurality of power resistors electrically connected in series to said main coil and each said resistor being disposed in a parallel relationship and connected to and controlled by a transistor for conditioning said current through said main coil as said main coil is energized.

5. The torque transfer device of claim 3 further including at least one of a clutch wear detection feature and a compensation feature and a safety check feature.

6. The torque transfer device of claim 1 wherein said feedback subassembly includes a force sensor operable to output a signal indicative of a force applied to said clutch, said control system determining a target torque to be transferred by said clutch and a target application force based on the target torque to vary the electrical input to said electromagnetic actuator to perform closed loop control of the position of said armature.

7. The torque transfer device of claim 1 wherein said feedback subassembly includes a force sensor positioned within a clutch actuation force load path and operable to output a signal indicative of a force applied to said clutch, said control system including a controller operable to control said electromagnetic actuator to vary the force applied to said clutch based on the force sensor signal.

8. The torque transfer device of claim 7 wherein said force sensor includes at least one piezoelectric ring coupled with said electromagnetic actuator for outputting a signal indicative of a compressive force of said electromagnetic actuator.

9. The torque transfer device of claim 2 wherein said control system includes:
a vehicle input module for collecting data provided by the vehicle sensors;
a target torque module for receiving the data from said vehicle input module and determining a target torque to be generated by said clutch;
an armature position vs. flux module for generating a magnetic flux vs. current data set and an armature position vs. current data set;
a force vs. flux module for determining the force acting on said armature as a function of magnetic flux;
a torque vs. position module for estimating the torque transferred between said first shaft and said second shaft;
a target position module for determining said target armature position based on the target torque determined by said target torque module and information stored in said torque vs. position module;
a position feedback control module in communication with position sensor for comparing the actual position of said armature to said target armature position defined by said target position module;
a main coil energizing module for varying a magnitude of an electrical input to said electromagnetic actuator to provide closed loop position control of said armature; and
an armature position verification module for performing an armature position vs. magnetic flux data collection sequence.

10. The torque transfer device of claim 2 further including a housing and wherein said position sensor attaches to said housing for directly measuring a position of said armature relative to said housing.

11. The torque transfer device of claim 10 further including a multiplier for amplifying the travel of said armature.

12. The torque transfer device of claim 3 wherein said position sensor being disposed within said main coil.

13. A method of controlling an electromagnetic actuator for a clutch transferring torque between first and second shafts of a power transmission device in a vehicle, the method comprising:
determining vehicle operating characteristics;
determining a target clutch torque based on the vehicle operating characteristics;
determining a target position of an armature within the actuator based on the target torque;
determining an actual armature position;
determining whether the actual armature position is within a predetermined tolerance of the target armature position; and
performing closed loop position feedback control by varying an electrical input to the electromagnetic actuator to control the position of the armature based on the position sensor signal.

14. The method of claim 13 further defining the step of determining an actual armature position as determining the armature position based on a signal provided by a position sensor.

15. The method of claim 14 further defining the step of determining an actual armature position as:
generating a magnetic flux density with a main coil;
inducing an electromotive force in a search coil in response to the generated magnetic flux density from the main coil;
inputting the electromotive force induced in the search coil to a controller;
comparing the electromotive force induced in the search coil and the signal provided by the position sensor to a predetermined flux and armature position relationship to verify the armature position.

16. The method of claim 13 further defining the step of determining an actual armature position as:
activating and deactivating a plurality of transistors in different combinations;
supplying a discrete supply voltage to a main coil using the power resistors; and
determining a magnetic flux of the main coil using a search coil.

17. The method of claim 13 further defining the step of performing closed loop position feedback control as:
providing a torque increase signal (T_{INCREASE}) to a module configured to calculate a target magnetic flux density from the search coil in response to a torque increase being required during clutch engagement;
providing the calculated target magnetic flux density to a torque feedback module;
calculating a change in flux feedback to provide a target magnetic flux value corresponding to the target torque increase signal (T_{INCREASE});
providing an adjusted target torque signal to a drive circuit of the electromagnetic clutch actuator to control actuation of the clutch;
providing torque decrease signal (T_{DECREASE}) to a current feedback module;
calculating and outputting a driving current value (I_{DRIVE}) to be delivered to the drive circuit in response to a torque decrease being required during clutch engagement; and
feeding a current sensed by a current sensor in a power drive module (I_{SENSOR}) to a feedback module for use in modulated current control.

18. A method of controlling an electromagnetic actuator for a clutch transferring torque between first and second shafts of a power transmission device in a vehicle, the method comprising:
determining vehicle operating characteristics;
determining a target clutch torque based on the vehicle operating characteristics;
determining a target clutch actuation force based on the target torque;
determining an actual clutch actuation force based on a signal provided by a force sensor positioned within a clutch actuation force load path;
determining whether the actual clutch actuation force is within a predetermined tolerance of the target clutch actuation force; and
performing closed loop force feedback control by varying an electrical input to the electromagnetic actuator to control the clutch actuation force based on the force sensor signal.
